(19) United States
(12) Patent Application Publication
(10) Pub. No.: US 2008/0138789 A1
(43) Pub. Date: Jun. 12, 2008

(54) Reusable Device For Creating A Model Or Reproducing A Subject Manually

(76) Inventor: Walter Totino, Chatou (FR)

Correspondence Address: WALTER TOTINO, 96 BIS , RUE DES VIGNOBLES, CHATOU, F-78400, omitted

(21) Appl. No.: 11/813,685

(22) PCT Filed: Oct. 10, 2005
(86) PCT No.: PCT/FR05/02485

§ 371 Date: Jul. 11, 2007

(30) Foreign Application Priority Data
Feb. 11, 2005 (FR) 0501377

(51) Int. Cl. G09B 29/00

(52) U.S. Cl. 434/430

(57) ABSTRACT

The invention relates to a reusable device for creating a model or reproducing a subject manually from life (3D subject) or by means of scaled or non-scaled duplication (flat or cylindrical subject).

The inventive device comprises an overhead transparency (1) which has been pre-perforated to form a regular distribution of holes (1.a) over the entire surface thereof and a not-perforated overhead transparency (2). Said two overhead transparencies are stacked on top of one another such as to enable a subject (3) to be aimed and reproduced. A first drawing is divided into two complementary layouts (6/1) and (6/2). Depending on the case, the layout (6/1) can be used as it is (without being transferred) or it can be transferred to a support (7). The result (8/7) is obtained through the overhead transparency (1) which is put alone on the support (7), by drawing again over the layout (6/1). The device also comprises other components.

The inventive device is suitable, in a non-limiting manner, for preparatory sketches for drawing and painting and for creating charts for counted cross-stitching.

The present invention relates to a device to create a model or to manually reproduce a subject from life (subject 3D) or by means of scaled or non-scaled duplication (flat or cylindrical subject).

There are many solutions. Some impose systems of references whereas that is not essential for a subject from life (3D) or for a drawing to scale of a flat or cylindrical subject. Moreover, these systems of references are sometimes perturbing, in any case need a procedure requiring a great concentration which does not always facilitate the task of the beginner or which add steps reducing the productivity of the most confirmed. When it is not a system of references which is imposed, it is the medium of drawing which is imposed (and consequently, the single-colour, the nature of the final support, the drawing with lines only, the thickness of the drawing . . . ). It is also frequent that a device is more adapted inside than outside (because of the weight, the obstruction, the use of electricity . . . ), or is adapted more to the reproduction of a flat subject than of a subject from life (because of a lack of transparency, of a lack of sufficient rigidity, of an unsuited level of precision . . . ). Certain devices are not easily reusable for other subjects following a first use. Other devices, although reusable for a type of activity, have limitations which do not allow a use in several activities with different constraints (because of the inadequacy of their dimensions, the incompleteness of their components . . . ). The solutions can prove to be expensive with use (cost of the material, bad productivity . . . ).

The device according to the invention makes it possible to remedy these disadvantages. It comprises, according to a first characteristic, two overhead transparencies which are superimposed then are intercalated between the user and the subject to be reproduced. The first overhead transparency (on the user side) is pre-perforated with a regular distribution of the holes over the surface. The second overhead transparency (on the subject side) is not perforated at all. The shape, the size and the distribution of the holes on the first overhead transparency, the distance which separates them, as well as the respective thicknesses of the two overhead transparencies, can depend on the aim, the technique of the user, or the media used for the drawings. A given configuration is appropriate for a great number of cases.

If it is for a reproduction from life, the user looks at the subject 3D through the frame that the two overhead transparencies form and composes her/his scene (here the second overhead transparency ensures the rigidity of the unit). If it is for the reproduction of a flat (or even cylindrical) subject, the user puts the two overhead transparencies on the original (here the second overhead transparency ensures the protection of the original). In all the cases, once the overhead transparencies are correctly positioned, the user draws on the first overhead transparency what she/he intends to reproduce with the level of precision she/he is interested in. The two overhead transparencies being in contact, the first being pre-perforated, the drawing is composed in fact of a layout in dotted lines (dashed lines, mosaic . . . ) on each overhead transparency, one complementary of the other. The first overhead transparency is raised. The second overhead transparency remains in place. The user thus sees on top of her/his subject, on the second overhead transparency, a layout in dotted lines (dashed lines, mosaic . . . ) which makes it possible to keep a visual continuity with the intentions of reproduction, and to see what the result will look like. On the first overhead transparency also appears in dotted lines (dashed lines, mosaic . . . ) the complementary layout of the layout on the second overhead transparency. In fact, it is a guide. Depending on the case, this guide can be used just as it is (without being transferred) or can be transferred on a support. In the case of a transfer, one “draws again” on this guide by putting the first overhead transparency alone on the support. The media used for this second drawing are not necessarily those used for the first drawing. The user raises the first overhead transparency and sees on the support what she/he sees on the second overhead transparency: the transfer in dotted lines (dashed lines, mosaic . . . ). In most of the cases, these results (with or without transfer) are sufficient. It is enough that the shape, the size and the distribution of the holes, the distance which separates them, as well as the respective thicknesses of overhead transparencies, are in conformity with the aim. The user remains free to “complete” those results. Also, the first layout on the first overhead transparency is only a guide with which the user can take freedoms. The drawings are not limited to lines, no more than to the use of only one imposed medium. The user can “color” (or hatch) through holes of the first overhead transparency. The drawings can be multicolour and can use several media (felts, pens, pencils, charcoals, chalks, pastels, inks, paintings . . . ). In a non-limiting manner, overhead transparencies are made with semi-rigid plastic (polyester, polypropylene . . . ), light, erasable and washable, so allowing an easy transport, as well as a simple and fast re-use. In general, taking into account their respective roles, the second overhead transparency is thicker than the first one. The first overhead transparency is sufficiently thick to resist repeated handling and washings (including with hot water, even with solvents), while being enough thin to avoid phenomena of “rebound” of the drawing medium that would produce, in the case of a transfer, marks which would be too marked for certain activities (for example, on paper or canvas in the case of sketching for drawing or painting). The phenomena of “rebound” can also be reduced in “bevelling” in the thickness the holes of the first overhead transparency. The second overhead transparency is sufficiently thick to ensure rigidity when that is necessary (for a subject from life, for example).

According to particular modes of realization:
the two overhead transparencies can be framed within their respective frames. The two frames interlock one on the other for the first drawing. In the case of a transfer, the frame with the first overhead transparency will come to be interlocked directly on the support or on a plate on which the support is put. The frame with the second overhead transparency remains in place. After the second drawing on the support through the first overhead transparency, one withdraws at least the first overhead transparency out of its frame. The fitment of the first frame on a plate can be an alternative to maintain a support (a free paper sheet for example) without resorting to adhesive tape, grips or pins. The plate can be provided with the first frame.

For a reproduction from life (subject 3D), whether it is interlocked or not within the frame of the first overhead transparency, the frame of the second overhead transparency is maintained in position with any suitable means (tripod, fixings at the edges of the easel . . . ). For the reproduction of a subject 2D, the frame of the second overhead transparency is transformed into a rigid support by interlocking there a plate, the original coming to be put on this rigid support. The plates respectively associated with the two frames can be transparent and can offer storage capabilities (for the drawing media, among others).
a set of complementary overhead transparencies, with different sizes, allows enlargements (or reductions) of a flat (or even cylindrical) subject by squaring up (or down), taking advantage from the basic characteristics of the invention.
the second overhead transparency can itself be superimposed on a third overhead transparency with pre-printed lines of force (grid, diagonals, rule of thirds, . . . ), and even with a complete model, in order to help with the composition. One can provide such pre-printed overhead transparencies or the user can create them by herself/himself according to her/his own practices.
the holes of the first overhead transparency can themselves form lines of force (grid, diagonals, rule of thirds . . . ) thus making it possible to compose directly on the support without necessarily starting from any model.
in order to reduce the frame of aiming, it can be provided a set of opaque sheets with an opening of different size for each sheet. Such a sheet can be inserted behind the first overhead transparency and/or the second overhead transparency. It is thus simple to tally and reproduce a subject bound for a support with a size lower than the size of overhead transparencies. When the support is put on a plate, concentric frames can be marked on this plate to facilitate the centering of the support when it is smaller than the plate. In addition, these opaque sheets with reduced opening allow the reductions of a flat subject without resorting to squaring down. It is enough for that to aim at the flat subject like at a subject from life by taking the necessary backward step to obtain the wished reduction (the subject entirely within the reduced frame), then to transfer the layout on the support such as the invention allows it.
in order to exploit the first layout without transferring it, once raised after the first drawing (only), the first overhead transparency can itself be superimposed on a third overhead transparency with a grid homothetic of the holes of the first overhead transparency (obtaining, without any transfer of the subject, a temporary chart for counted cross-stitching, for example). Alternatively, this third overhead transparency can also be superimposed on the result of a transfer of the first layout on an intermediate support (on paper for example, obtaining a permanent chart for counted cross-stitching). The grid of this third overhead transparency can be “graduated” or correspond to standards in a number of “points per inch” (allowing the transfer of a chart directly on a fabric to be embroidered with cross-stitches, for example).
the first “overhead” can be non-transparent (made with paper for example). In this case, one can see perfectly through “netting” which the holes form. It is thus possible to adapt to very fluid media of drawing, or to well preserve the first layout for several successive uses of the same subject.

The annexed figures illustrate the invention:

FIG. 1 represents, in perspective view, according to a mode of realization, two overhead transparencies in front of a subject from life (3D).

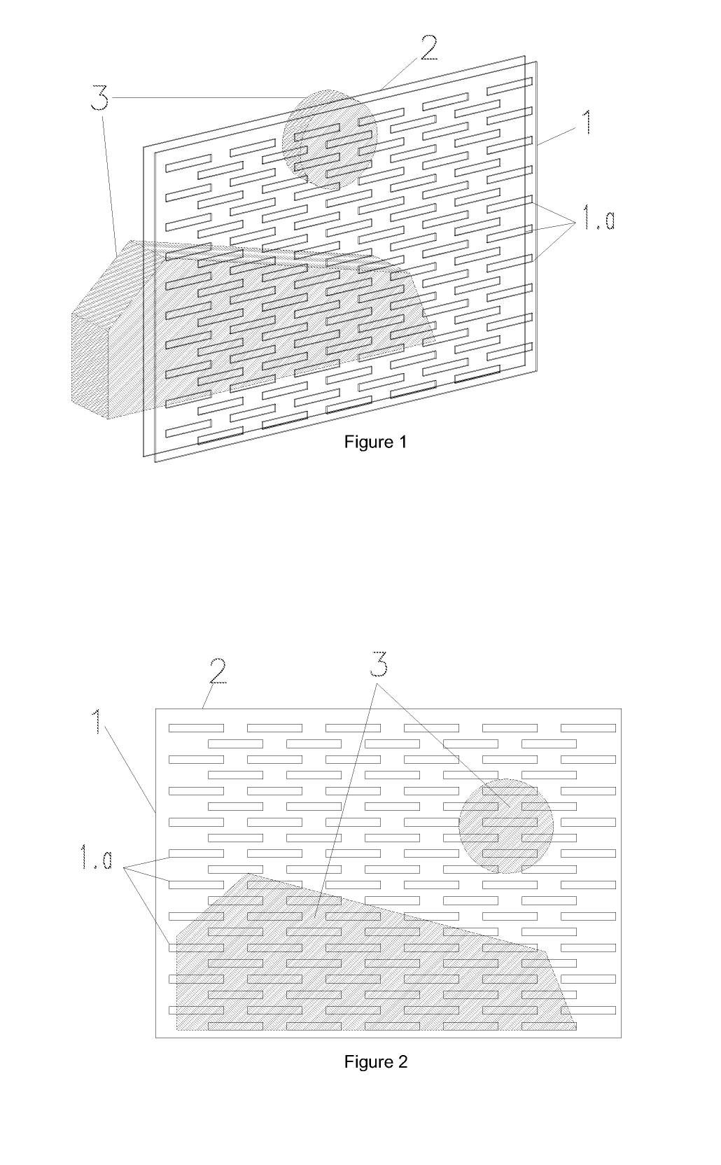

FIG. 2 represents, in front view, according to a mode of realization, a subject tallied through two superimposed overhead transparencies.

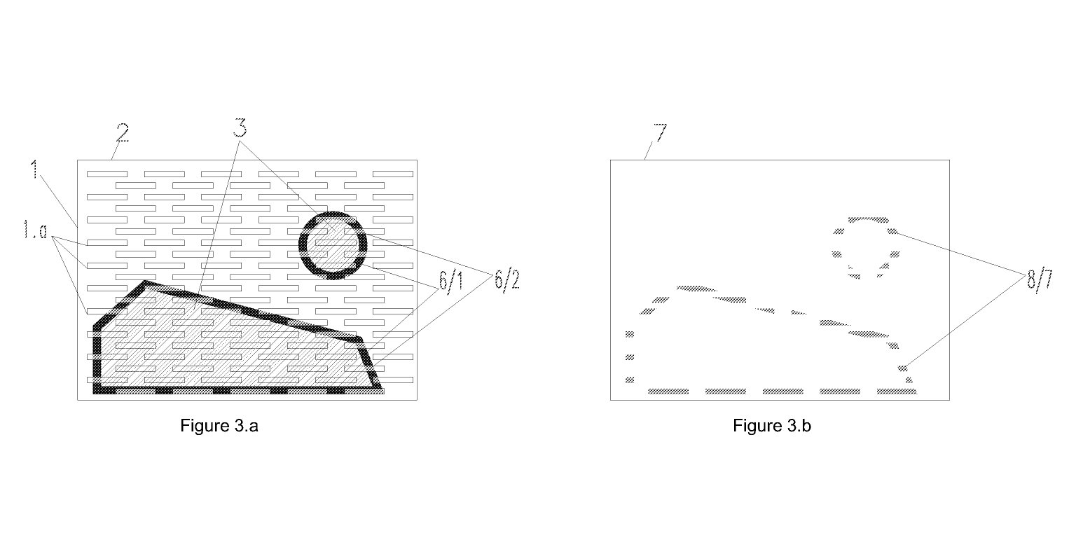

FIG. 3.a represents, in front view, according to a mode of realization, a subject tallied through two superimposed overhead transparencies, after the first drawing (on the left), side by side with the FIG. 3.b representing the result obtained on the support alone after the second drawing (on the right).

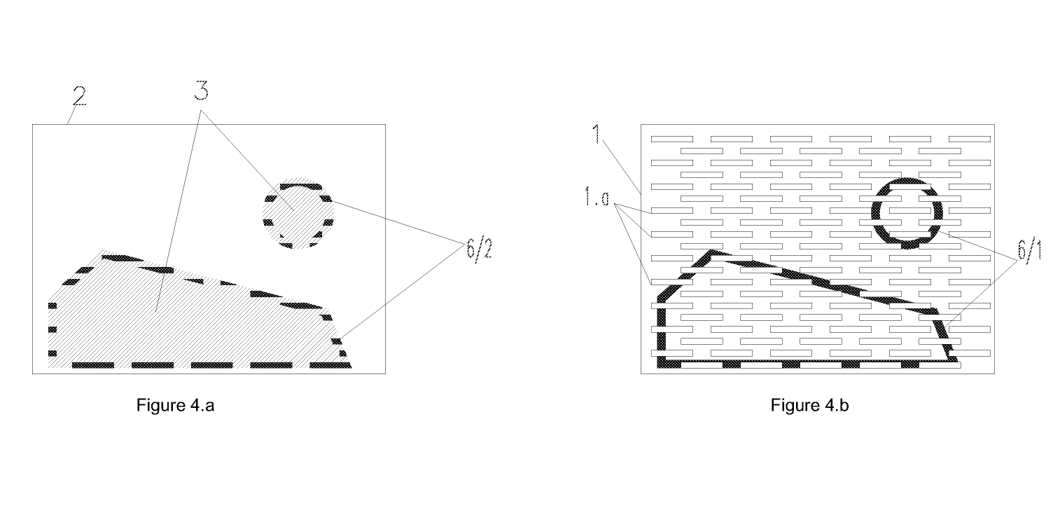

FIG. 4.a represents, in front view, according to a mode of realization, a subject through the second overhead transparency only, after the first drawing (on the left), side by side with the FIG. 4.b representing the first drawing on the first overhead transparency alone (on the right).

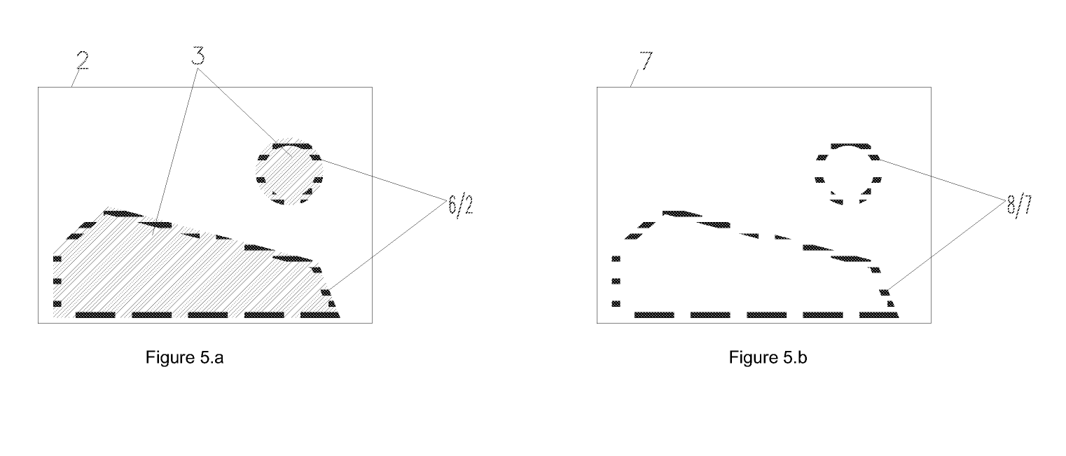

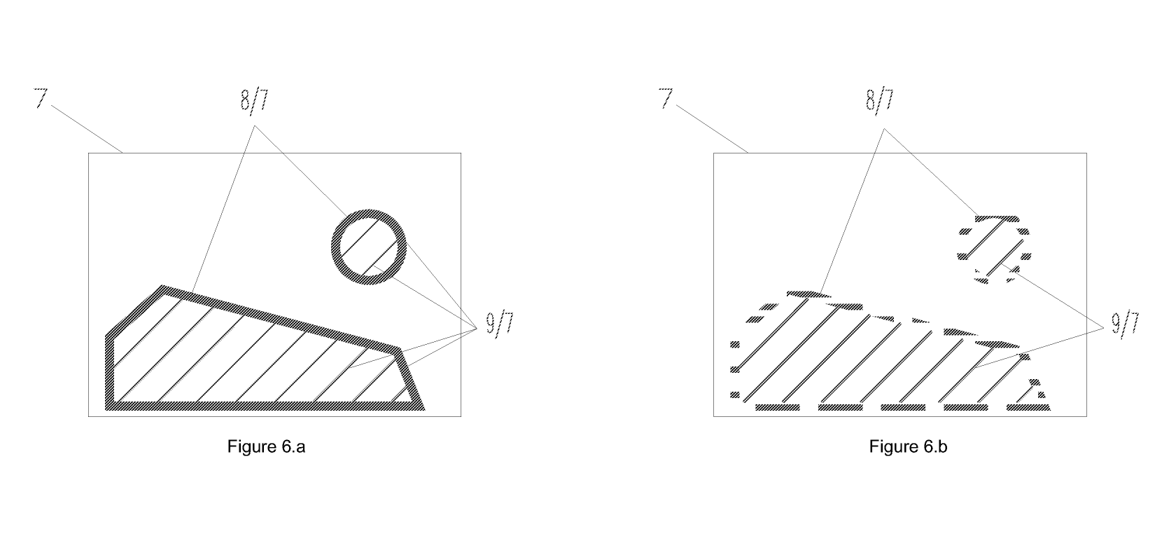

FIG. 5.a represents, in front view, according to a mode of realization, a subject through the second overhead transparency only, after the first drawing (on the left), side by side with the FIG. 5.b representing the result on the support (on the right).

FIGS. 6.a and 6.b represent, in front view, according to a mode of realization, two examples of result supplemented by free drawings directly on the support.

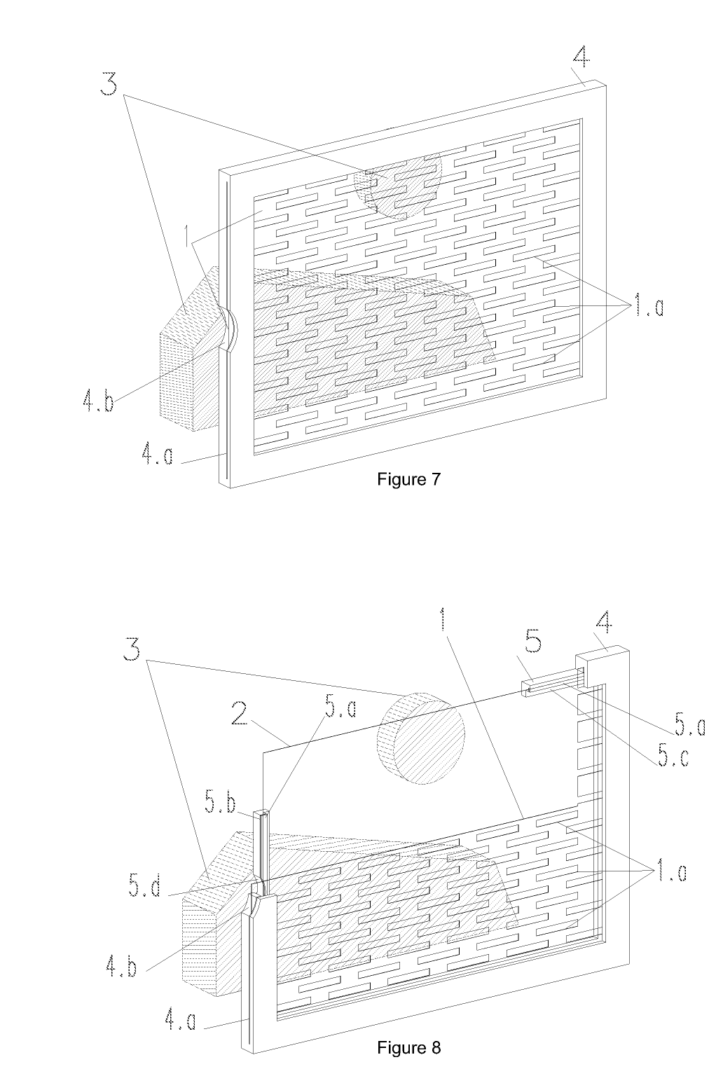

FIG. 7 represents, in perspective view, according to a mode of realization, a subject from life (3D) seen through two overhead transparencies within their interlocked frames.

FIG. 8 represents, in perspective view, the same thing as FIG. 7 while revealing sections of the first overhead transparency, as well as sections of the frames, in order to appreciate the shapes and the relative positions of the various components.

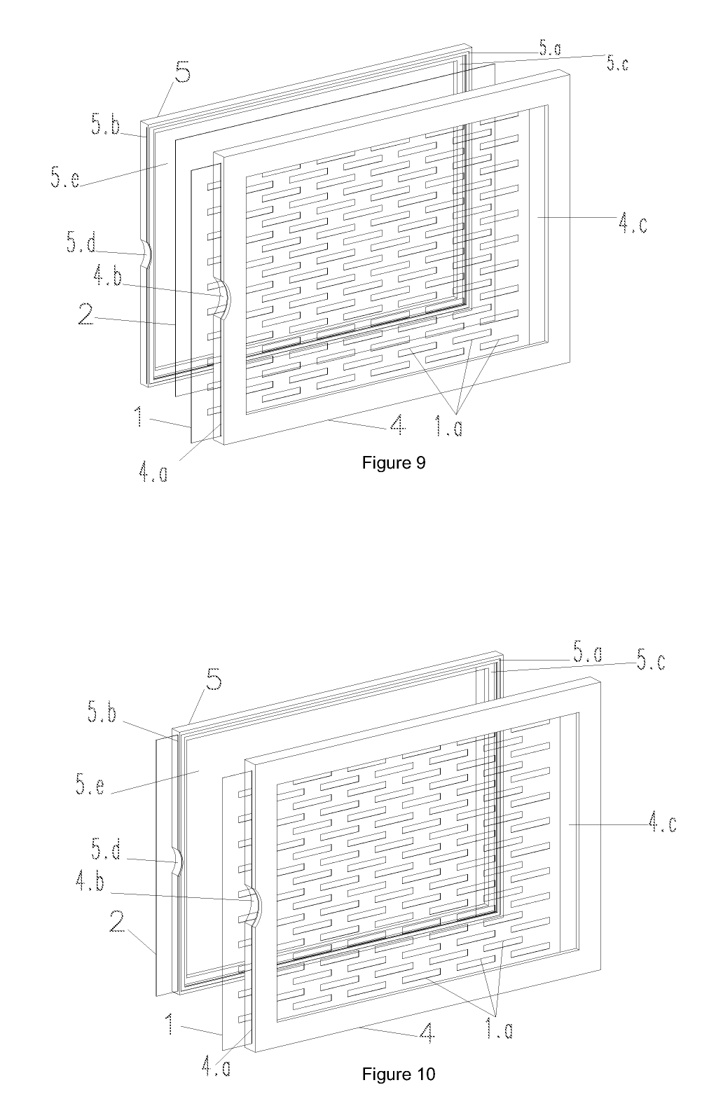

FIG. 9 represents, in perspective view, according to a mode of realization, two overhead transparencies, with their uncoupled frames (case of the aiming of a subject from life right before interlocking for the first drawing).

FIG. 10 represents, in perspective view, according to a mode of realization, two overhead transparencies, with their uncoupled frames (case of the aiming of a subject from life right after the first drawing and before placing the first overhead transparency within its frame on the support, for questions of readability the first drawing is not represented here).

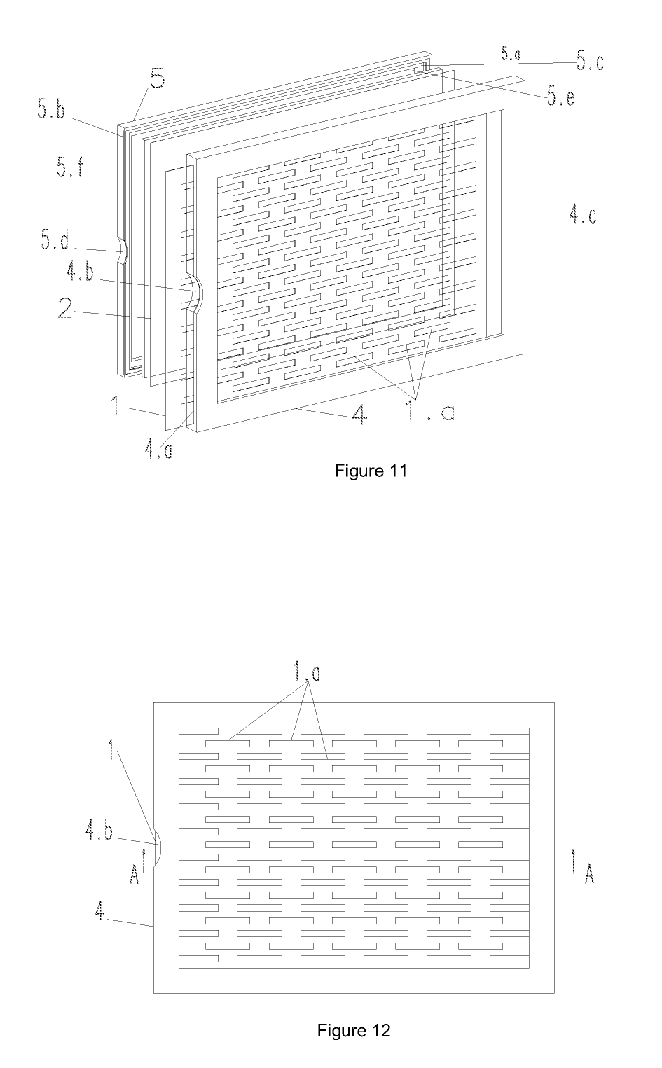

FIG. 11 represents, in perspective view, according to a mode of realization, two overhead transparencies, with their uncoupled frames (case of the aiming of a flat subject on rigid support right before interlocking for the first drawing).

FIG. 12 represents, in front view, according to a mode of realization, two overhead transparencies, with their interlocked frames. The first frame hides the second overhead transparency, as well as its frame.

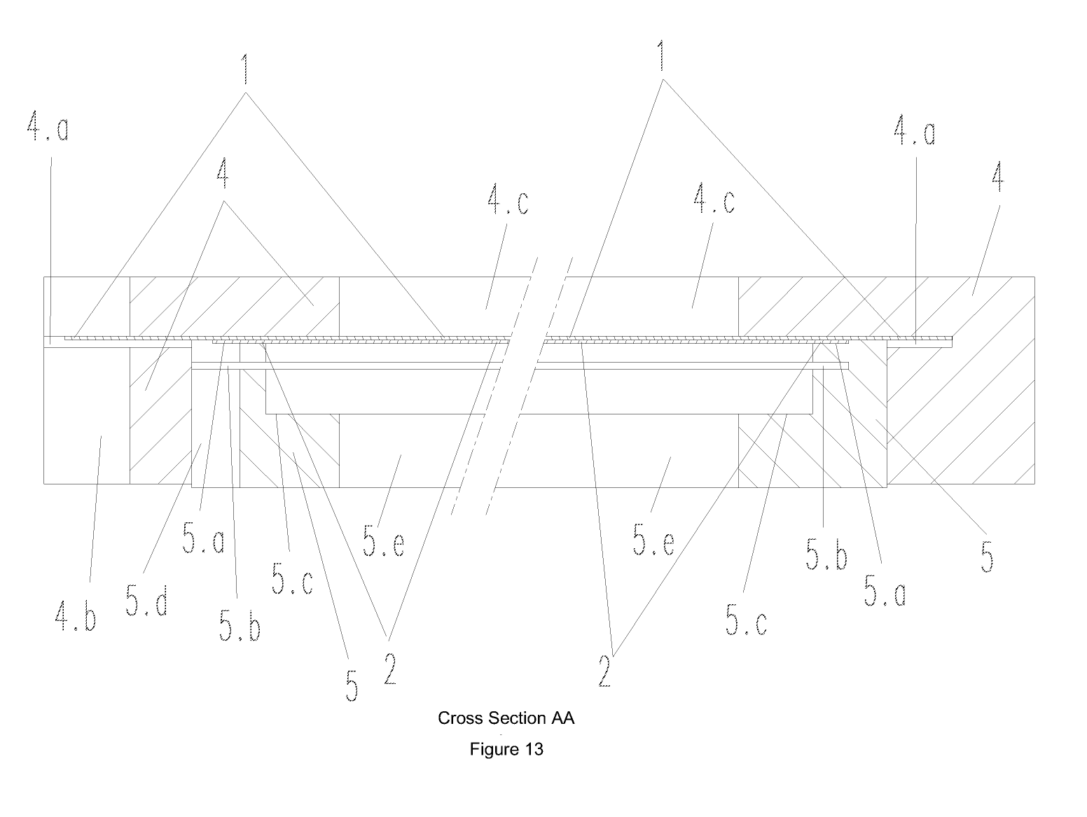

FIG. 13 represents, in section view, according to a mode of realization, two overhead transparencies, with their interlocked frames.

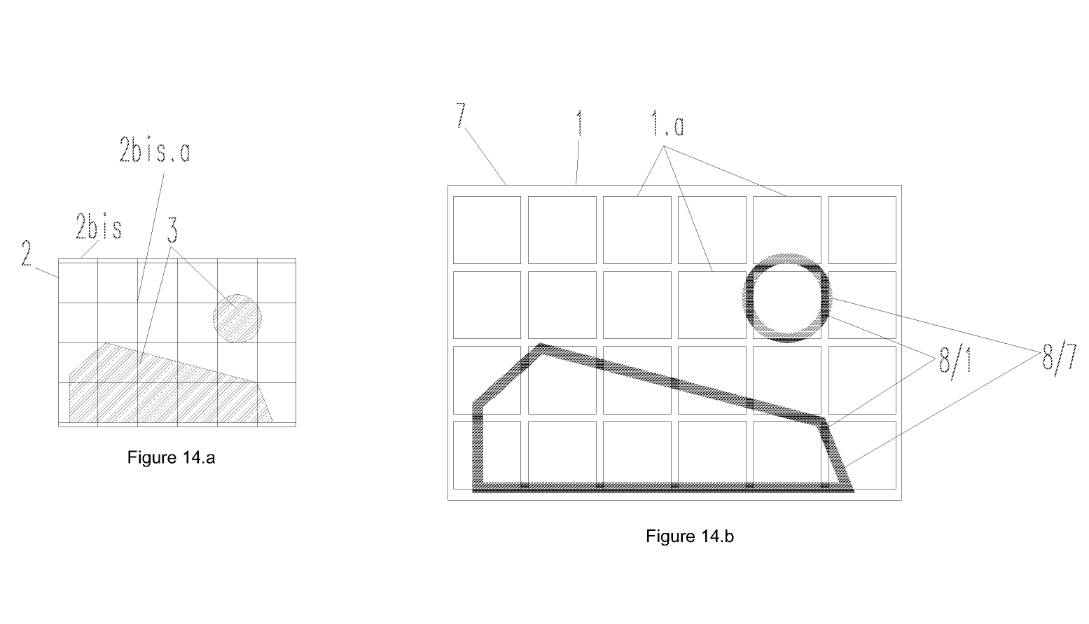

FIG. 14.a represents, in front view, according to a mode of realization, a subject tallied through the second overhead transparency superimposed on the third overhead transparency pre-printed with a grid for squaring (on the left), side by side with the FIG. 14.b representing a single drawing on the first overhead transparency, not pre-printed with a grid, and put on the support for squaring up (on the right).

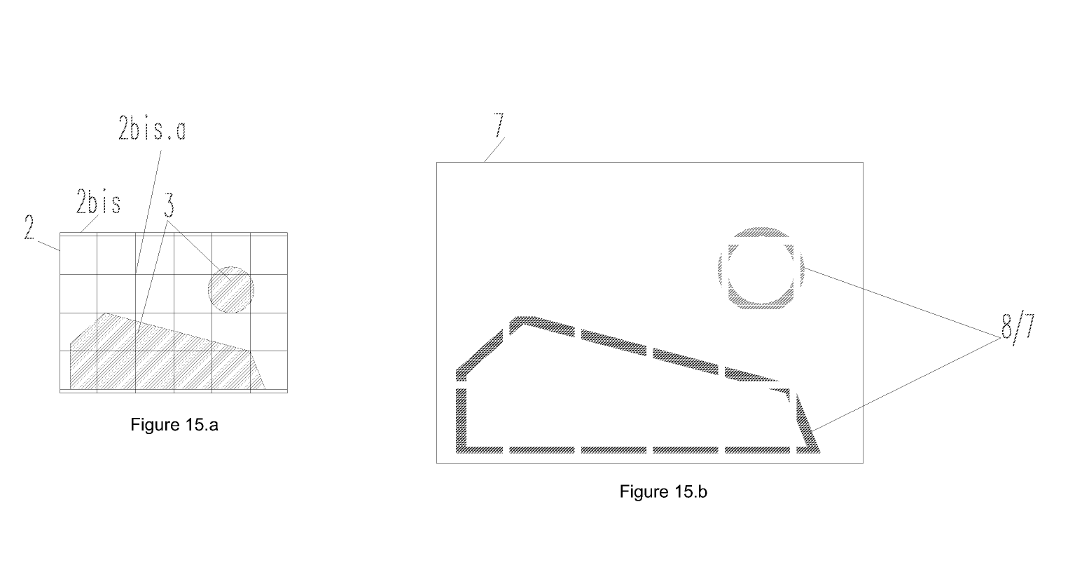

FIG. 15.a represents, in front view, according to a mode of realization, a subject tallied through the second overhead transparency superimposed on the third overhead transparency pre-printed with a grid for squaring (on the left), side by side with the FIG. 15.b representing an enlargement obtained by a single drawing according to the FIG. 14.b (on the right).

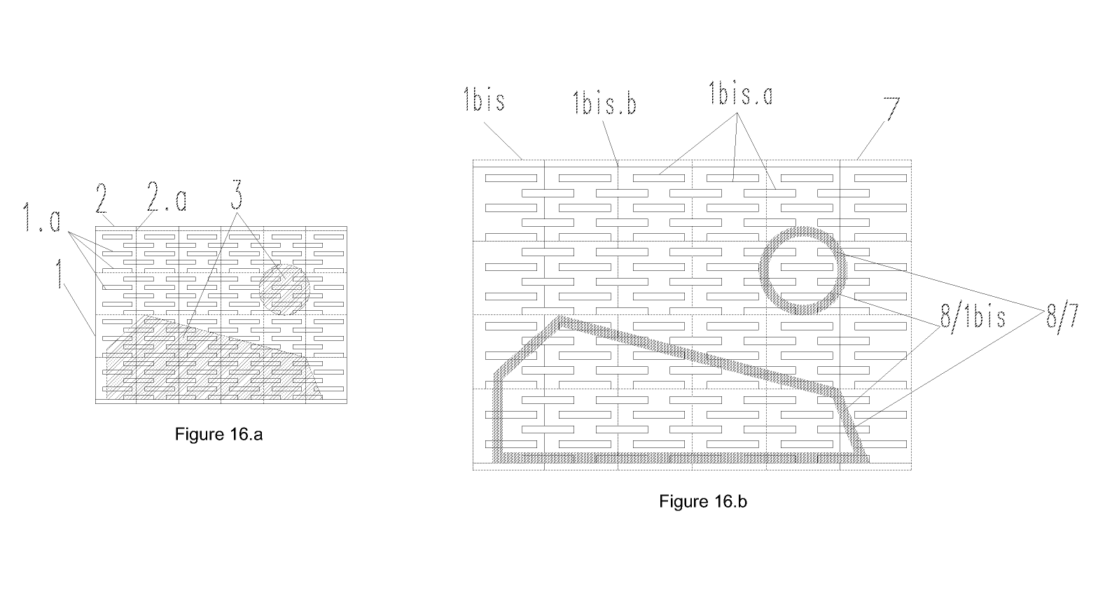

FIG. 16.a represents, in front view, according to a mode of realization, a subject tallied through the first overhead transparency superimposed on the second overhead transparency pre-printed with a grid for squaring with more reference mark by exploiting the positions of the holes on the first overhead transparency on top of the grid of the second overhead transparency (on the left), side by side with the FIG. 16.b representing a single drawing on another “first overhead transparency” pre-printed with a grid and put on the support for squaring up (on the right).

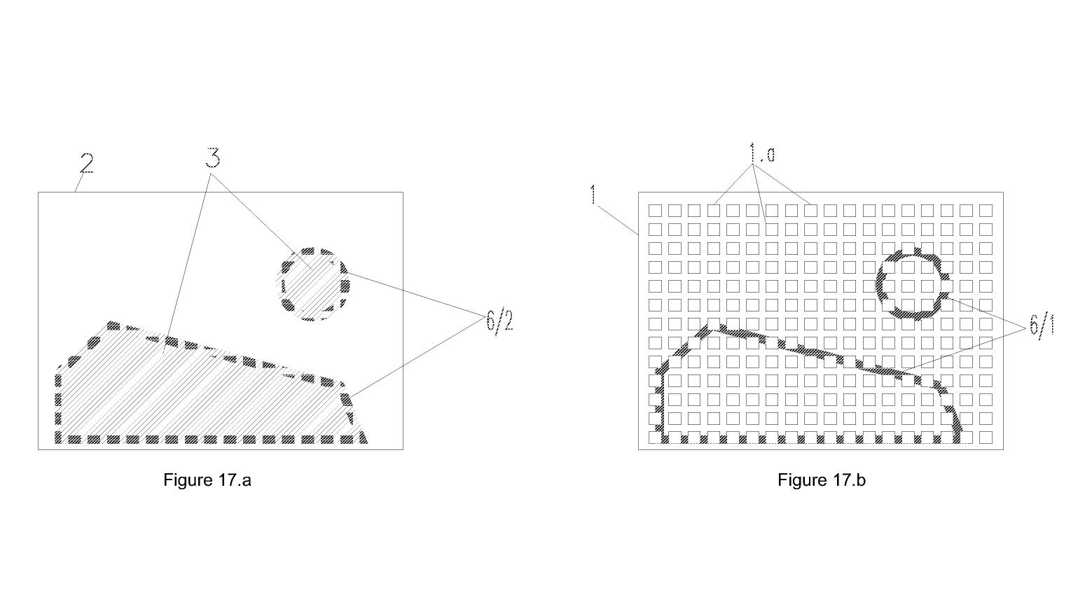

FIG. 17.a represents, in front view, according to a mode of realization, a subject through the second overhead transparency alone, after the first drawing (on the left), side by side with the FIG. 17.b representing the first drawing on the first overhead transparency alone (on the right). Sights similar to the FIGS. 4.a and 4.b, but in another mode of realization of the first overhead transparency with holes with different shape, size and distribution.

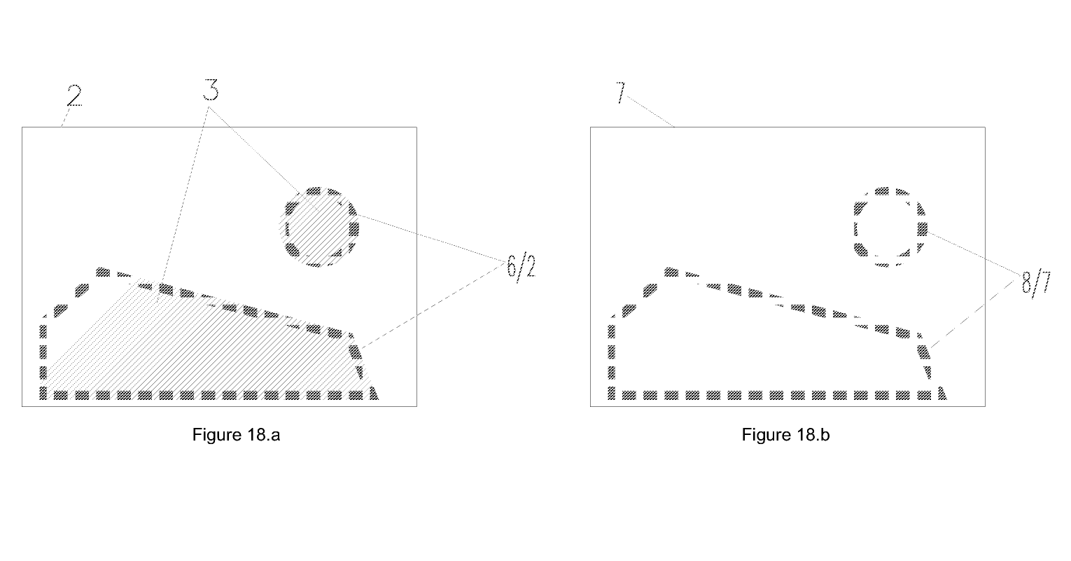

FIG. 18.a represents, in front view, according to a mode of realization, a subject through the second overhead transparency alone, after the first drawing (on the left), side by side with the FIG. 18.b representing the result on the support (on the right). Sights similar to the FIGS. 5.a and 5.b, but in another mode of realization of the first overhead transparency with holes with different shape, size and distribution.

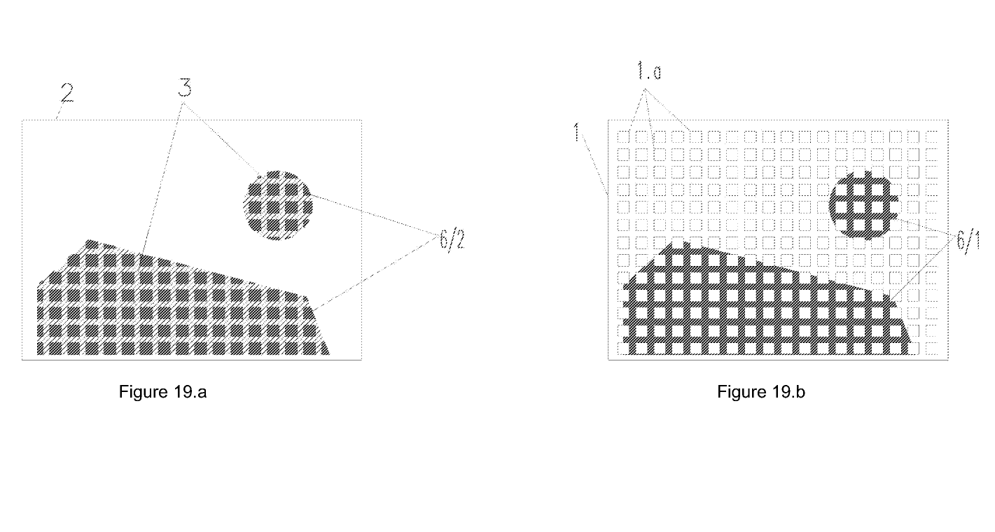

FIG. 19.a represents, in front view, according to a mode of realization, a subject through the second overhead transparency alone, after the first drawing (on the left), side by side with the FIG. 19.b representing the first drawing on the first overhead transparency alone (on the right). Sights similar to the FIGS. 17.a and 1 7.b, but in “coloring” rather than limiting to line contours.

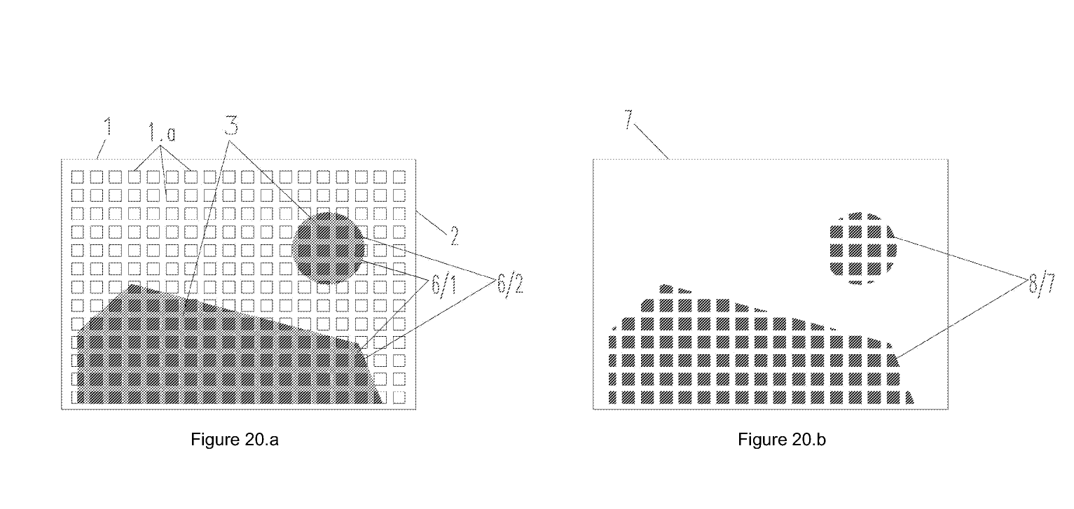

FIG. 20.a represents, in front view, according to a mode of realization, a subject through the two overhead transparencies superimposed, after the first drawing (on the left), side by side with the FIG. 20.b representing the result obtained on the support alone after the second drawing (on the right). Sights similar to the FIGS. 3.a and 3.b, but in “coloring” rather than limiting to line contours in order to obtain a mosaic.

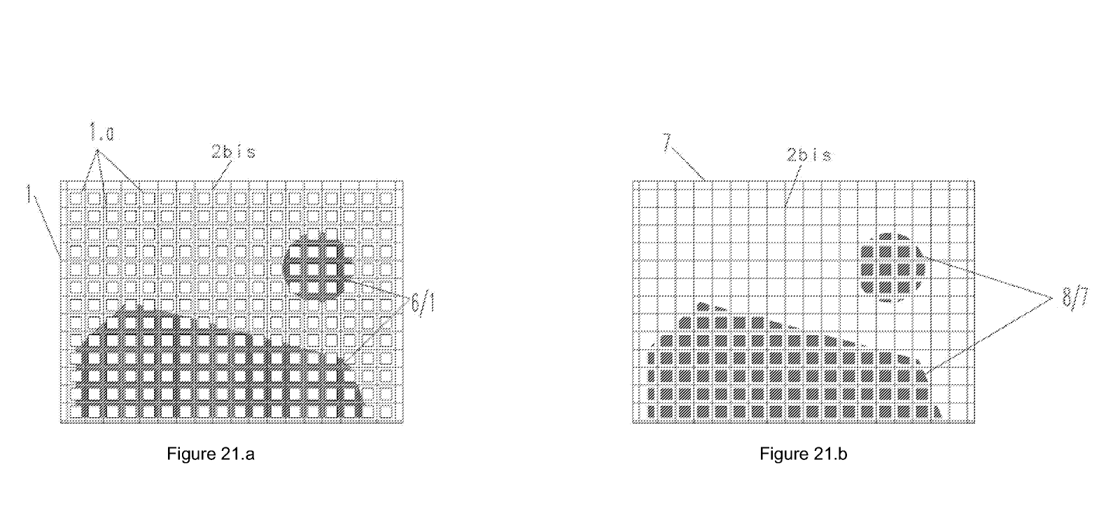

FIG. 21.a represents, in front view, according to a mode of realization, the first drawing on the first overhead transparency superimposed on the third overhead transparency pre-printed with a grid for directly obtaining a precise temporary chart without transferring on a support (on the left), side by side with the FIG. 21.b representing the third overhead transparency pre-printed with a grid and put on the permanent chart obtained on the support alone after a transfer (on the right). In other words, two possible ways to obtain, for example, a chart for counted cross-stitching.

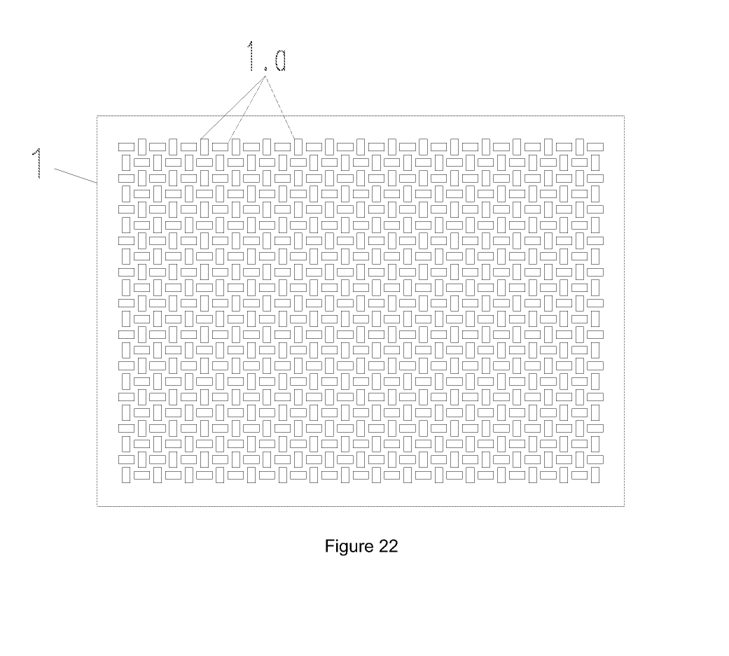

FIG. 22 represents, in front view, according to a mode of realization, the first overhead transparency alone (rectangular holes in staggered rows and columns) offering a help to free-hand drawing of horizontal and vertical lines, while remaining adapted to the precise drawing of curved lines.

In reference to those figures, the device comprises a overhead transparency (1) pre-perforated with a regular distribution of holes (1.a) over the entire surface (with margins) and a not-perforated overhead transparency (2). These two overhead transparencies are superimposed [(1) in front of (2)] thus allowing the aiming and the reproduction of a subject (3).

The two overhead transparencies (1) and (2) are in contact to allow a first drawing of the subject (3). This first drawing is divided into two complementary layouts: one layout (6/1) appearing on overhead transparency (1) and one layout (6/2) appearing on overhead transparency (2). The layout (6/1) is used as a guide. Depending on the case, this guide can be used as it is (without being transferred) or it can be transferred to a support (7). In the case of a transfer, the result (8/7) is obtained, through overhead transparency (1) put alone on the support (7), in “drawing again” on the layout (6/1). This result of transfer (8/7) can be supplemented by a drawing (9/7) directly on the support.

In the particular mode according to FIGS. 7, 8, 9, 10, 11, 12 and 13, overhead transparencies (1) and (2) are associated with their respective frames (4) and (5) interlocking one on the other.

The frame (4) comprises a slit (4.a) which accommodates overhead transparency (1). The notch (4.b) makes it possible to easily withdraw the overhead transparency (1) out of the frame (4). The opening (4.c) of the frame (4) makes it possible to see the subject (3), as well as, in the case of a transfer, the support (7) on which takes place the transfer (8/7) after fitting the frame (4) on the support (7).

The frame (5) comprises a rabbet (5.a) for centering overhead transparency (2). The opening (5.e) of the frame (5) makes it possible to see the subject (3). The slit (5.b) accommodates overhead transparency (2) for a possible second stage. The notch (5.d) makes it possible to easily withdraw the overhead transparency (2) out of the frame (5).The rabbet (5.c) accommodates the plate (5.f) which transforms the frame (5) into rigid support for a flat subject (3). The plate (5.f) can be transparent. The size of the opening (5.e) of the frame (5) is higher or equal than the opening (4.c) of the frame (4).

In the particular mode according to FIGS. 14, 15 and 16, to allow scaling up (or down), the device comprises sets of overhead transparencies (2) [(2bis)] pre-printed with a grid (2.a) [(2bis.a] and associated with sets of overhead transparencies (1) whose holes (1.a) form squares homothetic of the grid (2.a) [(2bis.a)], or, associated with overhead transparencies (1bis), pre-perforated to form a regular distribution of holes (1bis.a) over the entire surface, homothetic of the holes (1.a), and pre-printed with a grid (1bis.b), homothetic of grid (2.a) [2bis.a ]. In fact, the grid can be any type of lines of force (squares, diagonals, rule of thirds . . . ). The association of overhead transparencies (1) and (2) [(2bis)] to overhead transparency (1bis) makes it possible to exploit the positions of the holes (1.a) on overhead transparency (1) on top of the grid of the second overhead transparency (2) [(2bis)]. That forms a “squaring of the squaring” to offer more reference marks if necessary.

In the particular mode according to FIGS. 17, 18, 19, 20 and 21, as a non-restrictive example, the holes (1.a) of overhead transparency (1) have a different shape, size and distribution to adapt to other types of use (chart for counted cross-stitching, for example). The particular mode according to FIG. 22 is another example adapted in particular to the drawing from life (assistance with the horizontal and vertical lines, without prohibiting the curved lines).

According to a not illustrated mode, the holes of the first overhead transparency can themselves form lines of force (grids, diagonals, rule of thirds . . . ) allowing, in a non-restrictive manner, to use the first overhead transparency alone to, for example, compose directly on the support.

According to a not illustrated mode, the holes of the first overhead transparency can be bevelled in the thickness in order to reduce the phenomena of “rebound” in the case of a transfer on a support.

According to not illustrated alternatives, for the first drawing, overhead transparency (2) [(2bis)] can slip within the frame (4) by the slit (4.a) behind overhead transparency (1). In this case, the rabbet (5.a) and the notch (5.d) are not necessary. Moreover, overhead transparency (2) [(2bis)], as well as the slit (5.b), change dimensions as a consequence.

According to a not illustrated mode, in order to reduce the frame of aiming, opaque sheets with an opening can be inserted in the slit (4.a) behind overhead transparency (1) and/or in the slit (5.b) behind overhead transparency (2). This makes it possible to tally and reproduce a subject (3) bound for a support which size is lower than the size of the opening (4.c) of the frame (4). That also allows the reduction of a flat subject (3) without resorting to squaring down.

As non-limiting examples, the thickness of the first overhead transparency (1) lies between 0.03 mm and 0.20 mm. The thickness of the second overhead transparency (2) lies between 0.07 mm and 0.50 mm. The complementary sets of overhead transparencies (1bis) and (2bis) have, depending on their roles, thicknesses similar to those of overhead transparencies (1) or (2). The holes (1.a) [(1bis.a)] can be bevelled or not. The grid (2.a) [(2bis.a), (1bis.b)], measuring between 0.50 mm and 100 mm, can be “graduated” or correspond to standards in a number of “points per inch”. Dimensions of the holes (1.a) [(1bis.a)], as well as the distance which separates them, result from this according to the aim (medium of drawing, among others). The coefficients of the concerned homothetic transformations can be any value (including 1).

As non-restrictive examples, dimensions of the frame (4) are such as it can be interlocked on support with standard formats (Portrait/Landscape canvas, block of paper for sketching or painting A3/A4/“Raisin Size”, plate for free sheet A3/A4“Raisin Size” . . . ). Depending on the modes of realization, dimensions of the other components follow from this.

In a non-limiting manner, the device according to the invention is adapted for:
preparatory sketches for drawing and painting,
creation of precise charts for counted cross-stitching,
creation of models for mosaic, canvas, Fair Isle and beads
transfer of blueprint
painting on glass (including cylindrical)
toys (stamps for children . . . )
didactic games to teach children drawing, painting, writing . . .

The device according to the invention is addressed as well to amateurs as to professionals.

1. Device for creating a model or reproducing a subject (3) manually characterized in that it comprises a overhead transparency (1) pre-perforated with a regular distribution of the holes (1.a) over the surface thereof and a not-perforated overhead transparency (2). Said two overhead transparencies are superimposed on top of one another [(1) in front of (2)] such as to enable a subject (3) to be aimed and reproduced. A first drawing is divided into two complementary layouts: (6/1) on overhead transparency (1) and (6/2) on overhead transparency (2). The layout (6/1) can be used as it is (without being transferred) or it can be transferred to a support (7) to give the result (8/7) corresponding to the wished scheme in dotted lines (dashed lines, mosaic . . . ).

2. Device according to claim 1 characterized in that the holes (1.a) of overhead transparency (1) can form lines of force (grid, diagonals, rule of thirds . . . ).

3. Device according to one of the claims 1 or 2 characterized in that it comprises sets of overhead transparencies (2) [((2bis)], pre-printed with lines of force (2.a) [(2bis.a)], associated with sets of overhead transparencies (1) whose holes (1.a) form lines of force homothetic of the lines of force (2.a) [(2bis.a)], or, associated with overhead transparencies (1bis), pre-perforated with a regular distribution of the holes (1bis.a) over the surface, homothetic of the holes (1.a), and pre-printed with lines of force (1bis.b) homothetic of lines of force [(2bis.a)]. The device also comprises sets of opaque sheets with openings with different sizes, lower than the size of overhead transparencies (1) and (2).

4. Device according to any of the preceding claims characterized in that overhead transparencies (1), (1bis), (2) and (2bis) are, in a non-limiting manner, made with semi-rigid plastic, light, erasable and washable. The thickness of overhead transparencies (2) [(2bis)] is higher or equal to the thickness of overhead transparencies (1) [(1bis)].

5. Device according to one of claims 1, 2 or 3 characterized in that “overhead” (1) [(1bis)] can be non-transparent (made with paper for example). In this case, one can see perfectly through “netting” formed by the holes (1.a) [(1bis.a)].

6. Device according to any of the preceding claims characterized in that the holes (1.a) [(1bis.a)] can be bevelled.

7. Device according to any of the preceding claims characterized in that overhead transparency (1) [(1bis)] is associated with a frame (4) offering a centered opening (4.c) and overhead transparency (2) [(2bis)] is associated with a frame (5) offering a centered opening (5.e). The two frames (4) and (5) interlock one on the other for the first drawing (6/1) and (6/2). In the case of a transfer, for the second drawing (8/7) through overhead transparency (1), the frame (4) is interlocked on the support (7) or a plate on which the support is put. The frames (4) and (5) can offer storage capabilities.

8. Device according to claim 7 characterized in that overhead transparency (1) [(1bis)] can be inserted in the frame (4) by the slit (4.a). A notch (4.b) is made on the side of the frame (4) corresponding to the entry of the slit (4.a).

9. Device according to claim 7 characterized in that overhead transparency (2) [(2bis)] is maintained tallied by the rabbet (5.a) during the first drawing (6/1) and (6/2), then inserted in the slit (5.b). A notch (5.d) is made on the side of the frame (5) corresponding to the entry of the slit (5.b).

10. Device according to claim 9 characterized in that, for the first drawing (6/1) and (6/2), overhead transparency (2) [(2bis)] can slip into the slit (4.a) of the frame (4) behind overhead transparency (1). In this case, the rabbet (5.a) and the notch (5.d) are not necessary. Moreover, overhead transparency (2) [(2bis)], as well as the slit (5.b), change dimensions as a consequence.

11. Device according to claim 9 characterized in that for the reproduction of a subject 2D, a plate (5.f) interlocks on the rabbet (5.c) of the frame (5) to obtain a rigid support on which is put the original (3) to be reproduced, or even a final support (7). The plate (5.f) can be transparent and can offer storage capabilities.
